(19) United States
(12) Patent Application Publication
(10) Pub. No.: US 2011/0224588 A1
(43) Pub. Date: Sep. 15, 2011

(54) Personel Massaging System

(76) Inventor: Rene Grippo, Boulder, CO (US)

(21) Appl. No.: 13/113,915

(22) Filed: May 23, 2011

Related U.S. Application Data
(63) Continuation-in-part of application No. 11/942,899, filed on Nov. 20, 2007.

(51) Int. Cl. A61H 7/00

(52) U.S. Cl. 601/135

(57) ABSTRACT

A personal massaging system for efficiently massaging hard-to-reach areas upon oneself. The personal massaging system generally includes an elongated support including a first linear portion and a second linear portion, wherein the first linear portion extends from the second linear portion and wherein the first linear portion is obtuse to the second linear portion. At least one massaging device extends from the elongated support, wherein the massaging device may be utilized to massage either hard-to-reach areas or easy-to-reach areas upon the user.

### RELATED APPLICATION

This continuation in part (CIP) patent application claims priority from U.S. patent application Ser. No. 11/942,899 filed on Nov. 20, 2007 by Rene Grippo of Boulder, Colo., US.

### TECHNICAL FIELD

The present invention relates generally to massagers and more specifically it relates to a personal massaging system for efficiently massaging hard-to-reach areas upon oneself.

### BACKGROUND OF INVENTION

Any discussion of the related art throughout the specification should in no way be considered as an admission that such related art is widely known or forms part of common general knowledge in the field.

Personal massagers have been in use for years. Typically, people utilize personal massagers to rub, apply pressure or apply an actuating force to any sore or tender muscles on themselves. Many massaging devices are designed to be utilized upon easy-to-reach places upon oneself, wherein the massaging device may be comprised of a small handheld configuration that can not extend to hard-to-reach areas (e.g. lower back, etc.). Often times, an individual's back muscles become sore. It may be difficult to comfortably reach one self's back muscles with many prior massaging devices. It can be appreciated that there has been massaging devices designed to be utilized on one self's back; however these massaging devices are generally either difficult to control while utilizing or may not efficiently reach all desired muscles thus not providing an adequate massage. Because of the inherent problems with the related art, there is a need for a new and improved personal massaging system for efficiently massaging hard to-reach areas upon oneself.

### SUMMARY OF INVENTION

The general purpose of the present invention is to provide a personal massaging system that has many of the advantages of the massaging apparatuses mentioned heretofore. The invention generally relates to a massaging apparatus which includes an elongated support including a first portion and a second portion, wherein the first portion extends from the second portion and wherein the first portion is transverse to the second portion. At least one massaging device extends from the elongated support, wherein the massaging device may be utilized to massage either hard-to-reach areas or easy-to-reach areas upon the user.

There has thus been outlined, rather broadly, some of the features of the invention in order that the detailed description thereof may be better understood, and in order that the present contribution to the art may be better appreciated. There are additional features of the invention that will be described hereinafter and that will form the subject matter of the claims appended hereto.

In this respect, before explaining at least one embodiment of the invention in detail, it is to be understood that the invention is not limited in its application to the details of construction or to the arrangements of the components set forth in the following description or illustrated in the drawings. The invention is capable of other embodiments and of being practiced and carried out in various ways. Also, it is to be understood that the phraseology and terminology employed herein are for the purpose of the description and should not be regarded as limiting.

An object is to provide a personal massaging system for efficiently massaging hard-to-reach areas upon oneself.

Another object is to provide a personal massaging system that is easy to utilize.

An additional object is to provide a personal massaging system that is portable.

A further object is to provide a personal massaging system that may be disassembled for easy storage.

Other objects and advantages of the present invention will become obvious to the reader and it is intended that these objects and advantages are within the scope of the present invention. To the accomplishment of the above and related objects, this invention may be embodied in the form illustrated in the accompanying drawings, attention being called to the fact, however, that the drawings are illustrative only, and that changes may be made in the specific construction illustrated and described within the scope of the appended claims.

### BRIEF DESCRIPTION OF DRAWINGS

Various other objects, features and attendant advantages of the present invention will become fully appreciated as the same becomes better understood when considered in conjunction with the accompanying drawings, in which like reference characters designate the same or similar parts throughout the several views, and wherein:

FIG. 1 is an upper perspective view of the personal massaging system;

FIG. 2 is an exploded upper perspective view of the personal massaging system;

FIG. 3 is a side view of the personal massaging system illustrating the outer massaging device swivally connected to the elongated support;

FIG. 4 is a side view of the personal massaging system in use, wherein the user is utilizing the personal massaging system to massage a hard-to-reach area;

FIG. 5 is a side view of the personal massaging system in use, wherein the user is utilizing the personal massaging system to massage an easy-to-reach area;

FIG. 6 is a longitudinal cross-sectional view of the personal massaging system;

FIG. 7 is a cutaway longitudinal cross-sectional view of the second portion illustrating a first method to attach the inner massaging device to the elongated support;

FIG. 8 is a cutaway longitudinal cross-sectional view of the second portion illustrating a second method to attach the inner massaging device to the elongated support;

FIG. 9 is an upper perspective view of the personal massaging system illustrating the elongated support comprised of an integral structure and an elongated slot extending along the elongated support to allow the inner massaging device to slidably adjust along the elongated support;

FIG. 10 is a side view of the personal massaging system as illustrated in FIG. 9;

FIG. 11 is a longitudinal cross-sectional view of the personal massaging system as illustrated in FIG. 9 and illustrating the inner massaging device being slidably adjusted within the slot;

FIG. 12 shows a perspective view of the personal massaging system in use utilizing the arcuate extension as a fulcrum pivot point on the surface on a floor to gain leverage for the force to be applied at the first massage portion via the handle from the user;

FIG. 13 shows a perspective view of the personal massaging system in use utilizing the arcuate extension again as a fulcrum pivot point on the surface on a floor to gain leverage for the force to be applied at the first massage portion via the handle from the user in a more remote location;

FIG. 14 shows a perspective view of the personal massaging system in use utilizing the arcuate extension as a fulcrum pivot point and the massage device as against the user's leg with the second portion trapped between the user's other leg and the couch seat with the user pushing down on the handle creating an end pivot at the second portion opposite of the handle;

FIG. 15 shows a perspective view of the personal massaging system in use utilizing the arcuate extension again as a fulcrum pivot point on the surface on a chair back to gain leverage for the force to be applied at the first massage portion via the handle from the user in a more remote location on the user's back; and

FIG. 16 shows a perspective view of the personal massaging system in use utilizing the retention straps disposed at the handle and the opposing second portion allowing the user to apply force at the retention straps to effectuate massage force at selected locations on their back from the massaging device.

### REFERENCE NUMBERS IN DRAWINGS

50 Personal massaging system
60 Elongated support
62 First end
63 Second end
70 First linear portion
71 Obtuse angle
80 Second linear portion
90 Massaging device, inner
100 Massaging device, outer
110 Handle
120 Cavity
130 Section
140 Section
150 First connecting portions
160 Attachment member
170 First channel
180 Coupler
190 Fasteners
200 Attachment opening
210 Attachment opening
220 Section
230 Angled coupler
240 Second connecting portions
250 Second channel
260 Outer connecting portion
270 Elongated slot
280 First attachment portion
290 First massaging portion
300 Second attachment portion
310 Second massaging portion
311 Swivally connected
320 Arcuate extension
330 Rib
331 Retention strap
340 Surface
341 Force at the massaging portion 90, 100, 290, or 310
342 Force at the handle 110 and/or the opposing second portion 80
350 User
360 Couch seat
370 Chair back
380 Longer moment arm
390 Shorter moment arm
400 Moment between the first linear portion and the second linear portion

### DETAILED DESCRIPTION

### A. Overview

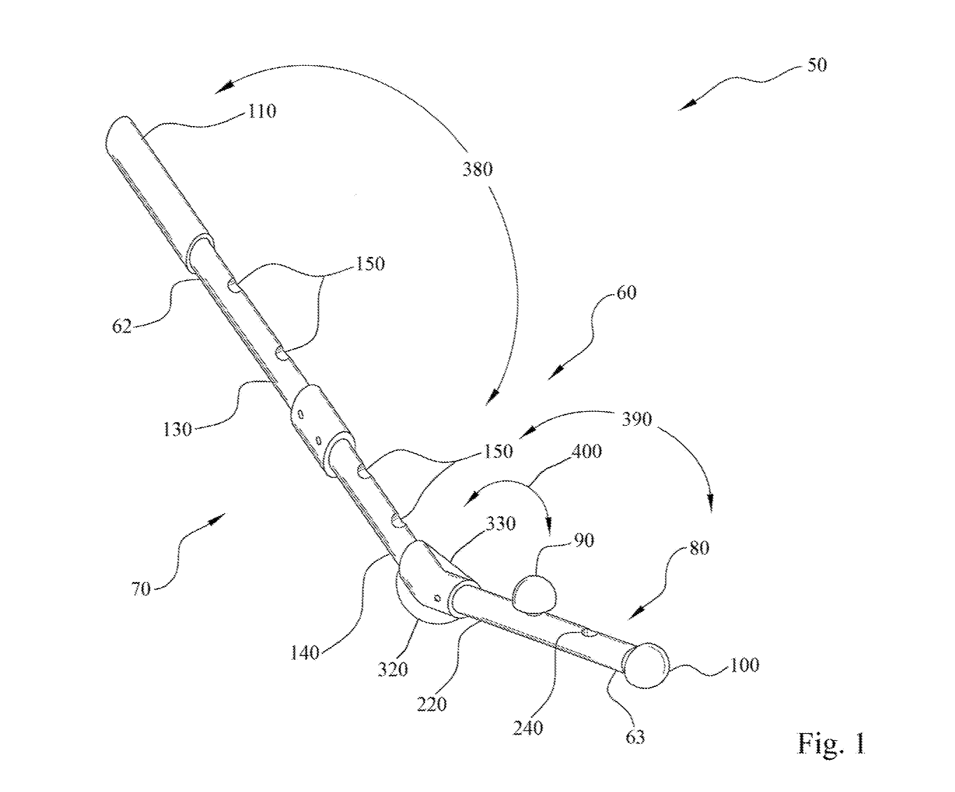

Turning now descriptively to the drawings, in which similar reference characters denote similar elements throughout the several views, FIGS. 1 through 16 illustrate a personal massaging system 50, which comprises an elongated support 60 including a first portion 70 and a second portion 80, wherein the first portion 70 extends from the second portion 80 and wherein the first portion 70 is transverse to the second portion 80. At least one massaging device 90, 100 extends from the elongated support 60, wherein the massaging device 90, 100 may be utilized to massage either hard-to-reach areas or easy-to-reach areas upon the user 350.

### B. Elongated Support

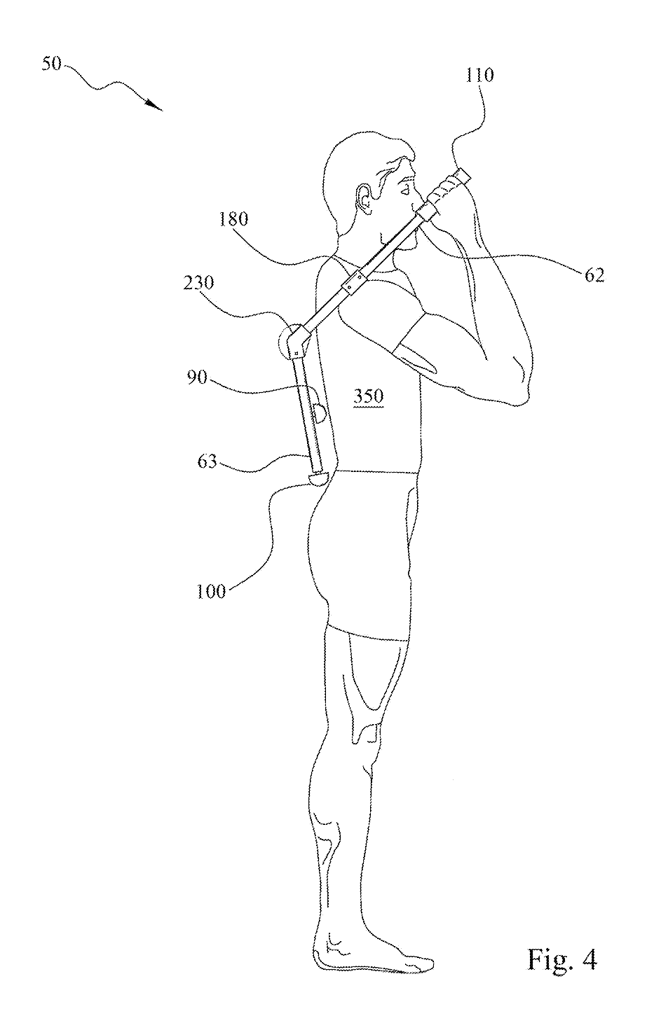

The elongated support 60 is comprised of a sufficient length between the first end 62 and the second end 63 for a user 350 to reach the lower portion of their back or other hard-to-reach areas with the second end 63 of the elongated support 60 while holding the elongated support 60 adjacent the first end 62 as illustrated in FIG. 4. The elongated support 60 is preferably comprised of a rigid and substantially lightweight material, such as but not limited to plastic to allow the user 350 to easily maneuver the elongated support 60.

The elongated support 60 is also preferably comprised of cylindrical configuration as illustrated in FIGS. 1 through 16 and may be substantially solid in configuration or hollow. It is appreciated that the elongated support 60 may be comprised of various other shaped configurations rather than the preferred embodiment.

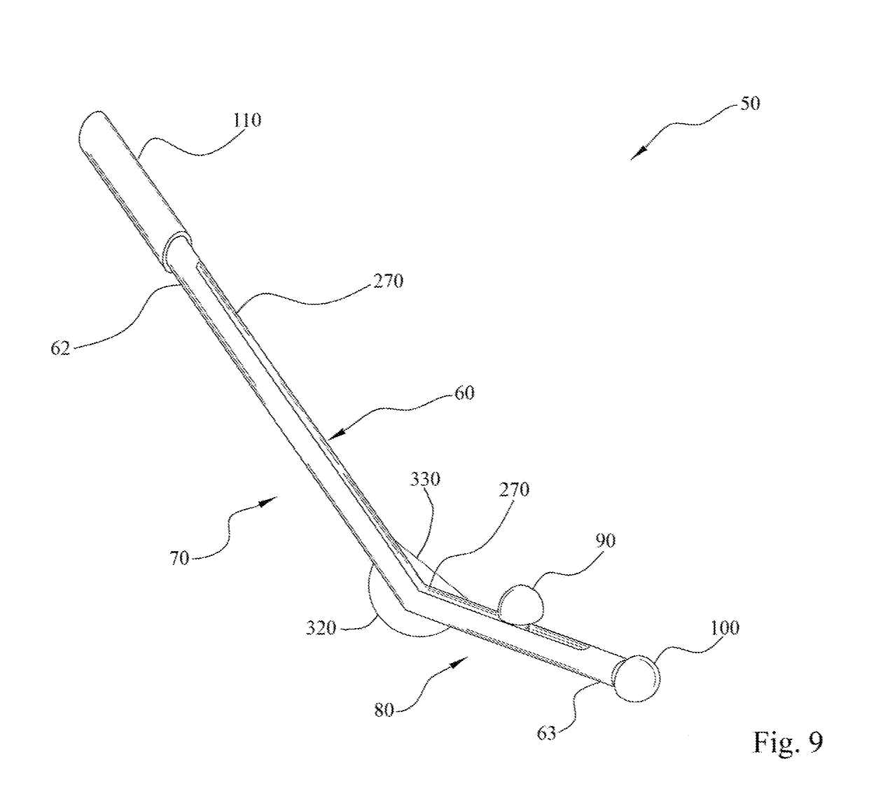

The elongated support 60 includes a first portion 70 and a second portion 80, wherein the second portion 80 extends from the first portion 70. The first portion 70 and the second portion 80 may be comprised of an integrally formed structure as illustrated in FIGS. 9 through 11 or may be separably connected as illustrated in FIGS. 1 through 6. Utilizing a separably connected configuration as illustrated in FIGS. 1 through 6 allows for easier storage and mobility of the present invention.

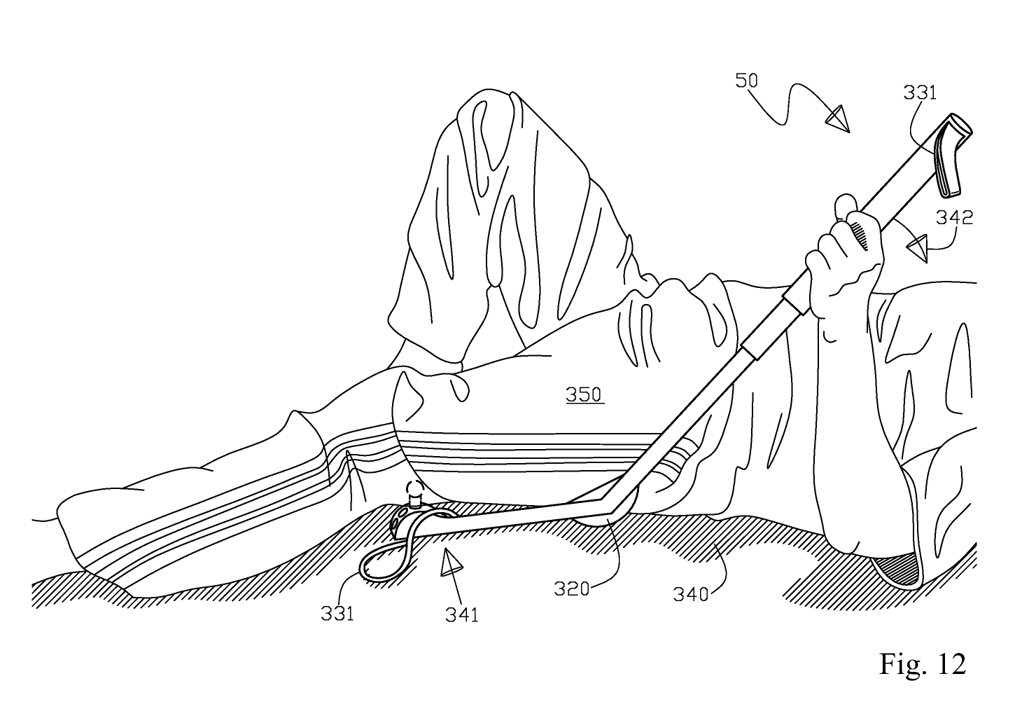

The first portion 70 and second portion 80 of the elongated support 60 are also preferably connected in an angled configuration to allow the elongated support 60 to reach around the user 350 and allow the user 350 to efficiently massage various portions of their back and other areas, as best shown in FIGS. 12 through 16. The first portion 70 and the second portion 80 further define a substantially L-shaped configuration and are substantially transverse to each other.

A handle 110 is also connected to the first portion 70 of the elongated support 60 opposite the second portion 80 as illustrated in FIGS. 1 through 6. It is appreciated that the handle 110 may be fixedly connected or removably connected to the first portion 70. The handle 110 is also preferably formed in an ergonomic configuration so that a user 350 may comfortably grasp the handle 110 when utilizing the present invention. The handle 110 also preferably includes a cavity 120 longitudinally extending within the handle 110, wherein the first portion 70 is inserted within the cavity 120 to connect the handle 110 to the first portion 70 of the elongated support 60.

i. First Portion

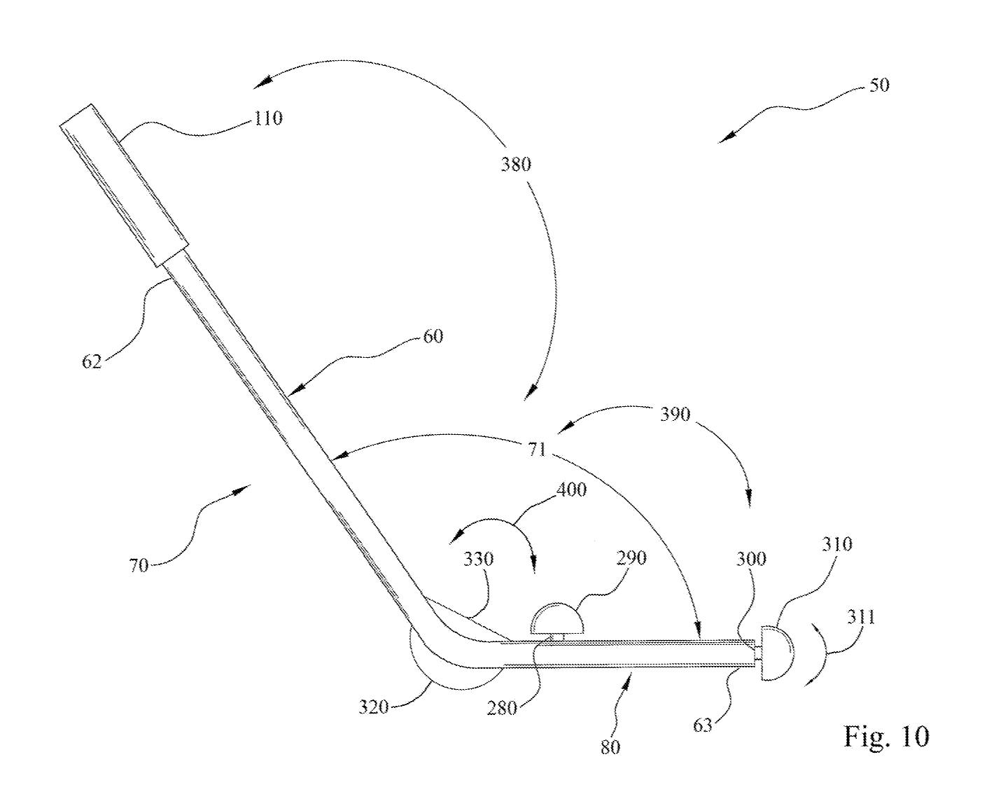

The first portion 70 is preferably aligned and concentric with the handle 110. The first portion 70 may be comprised of an integrally formed structure as illustrated in FIGS. 9 and 10 or may be comprised of a plurality of sections 130, 140 removably connected together as illustrated in FIGS. 1 through 3. The first portion 70 includes a plurality of first connecting portions 150 spaced along a longitudinal axis of the first portion 70. The first connecting portions 150 are also directed towards the area formed between the first portion 70 and the second portion 80 and the side of the elongated support 60 that is positioned adjacent the user 350 while in use (i.e. inside of elongated support 60).

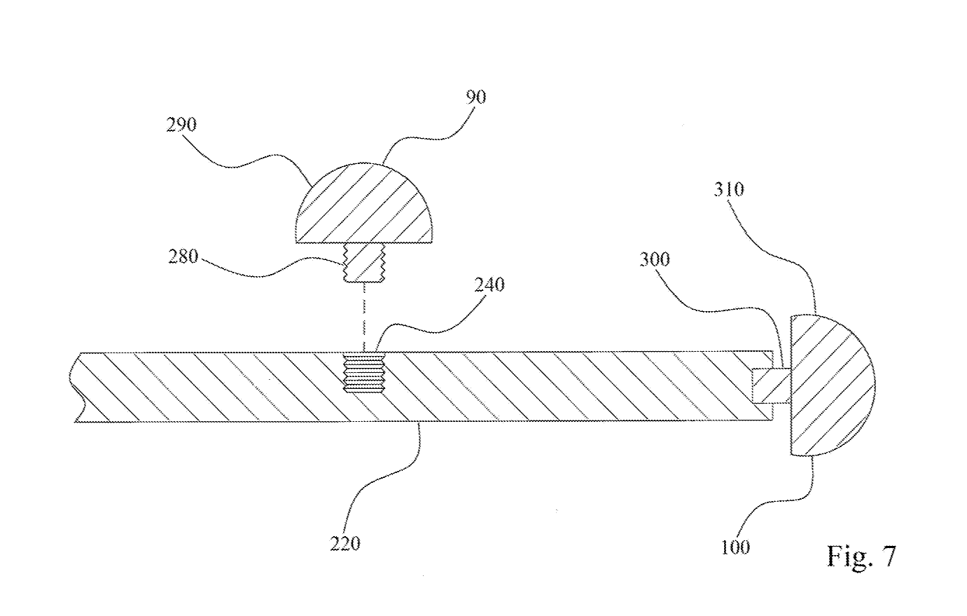

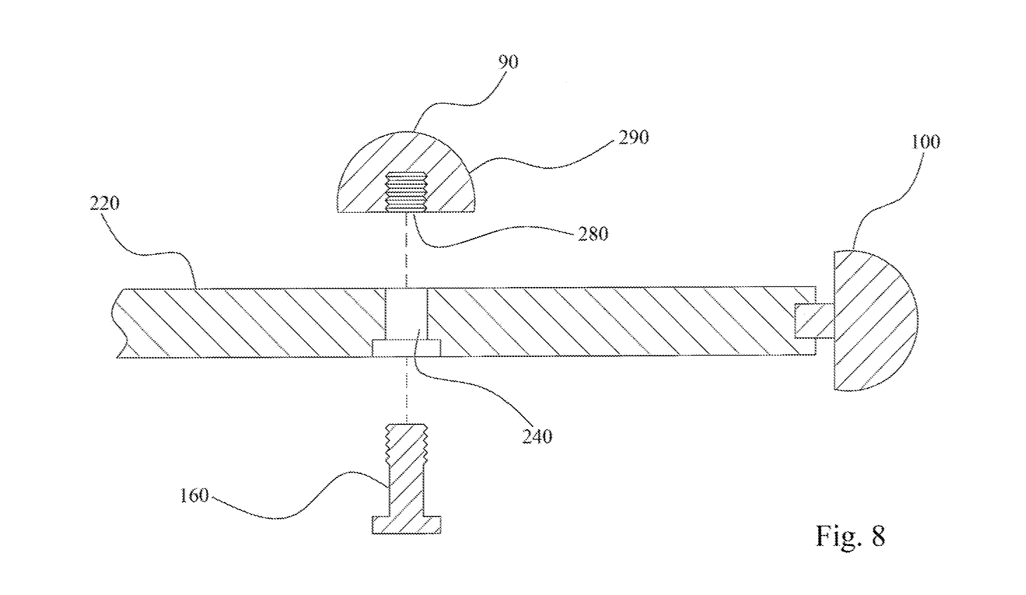

The first connecting portions 150 are also preferably perpendicular to the longitudinal axis of the first portion 70. The first connecting portions 150 may extend from the first portion 70 or may extend within the first portion 70 as in an opening configuration. When the first connecting portion 150 is configured as an opening, it is appreciated that the opening 150 may extend partially or completely through the first portion 70 similar to as shown with the second portion 80 in FIGS. 7 and 8. The first portion 70 includes the plurality of first connecting portions 150 to allow the user 350 to adjust the positioning of the inner massaging device 90 at various longitudinal positions upon the first portion 70 or to connect a plurality of inner massaging devices 90 to the first portion 70.

The first connecting portions 150 may also be threadably formed. The first connecting portions 150 may also include a first recessed portion to receive the head of a bolt (i.e. attachment member 160). The head of the attachment member 160 thus remains flush with the outside of the elongated support 60 to prevent the head from engaging the user 350 when utilizing the present invention.

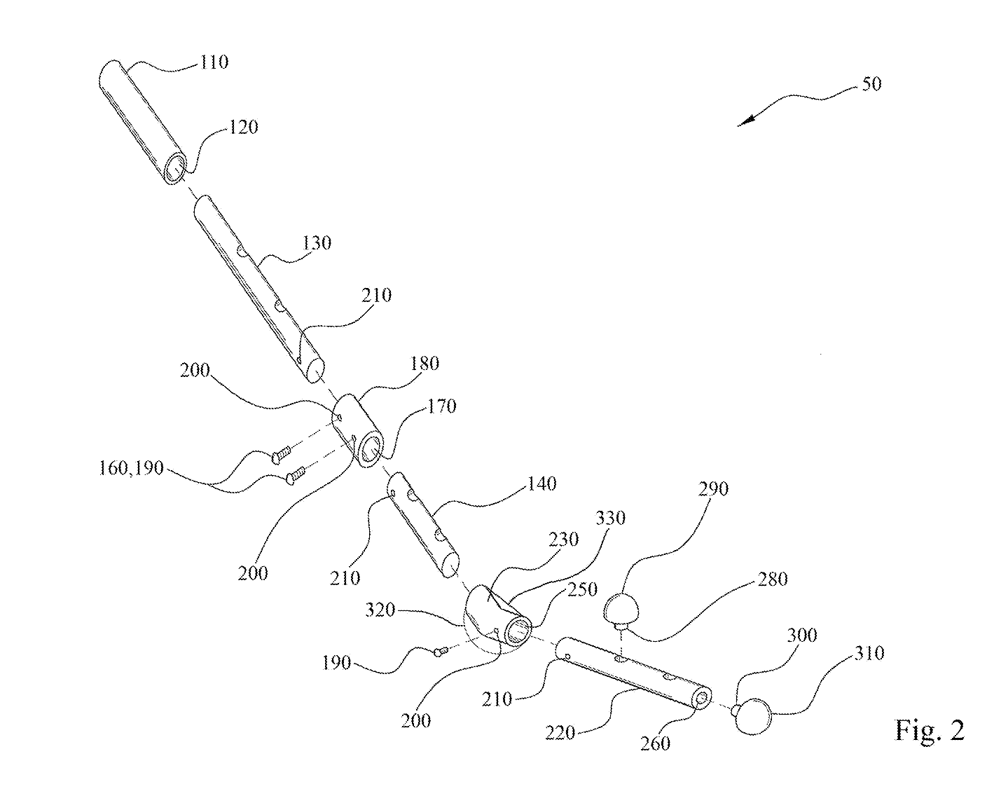

The first portion 70 may also be comprised of a plurality of sections 130, 140 as illustrated in FIGS. 1 through 6. The first section 130 and the second section 140 may be removably connected via extending within opposing ends of a first channel 170 of a coupler 180. The coupler 180 may be comprised of various configurations all which efficiently connect the first section 130 to the second section 140. It is appreciated that the first section 130 and the second section 140 may be secured to the coupler 180 via various methods, such as but not limited to fasteners 190 extending through attachment openings 200, 210 as illustrated in FIG. 2 and similar to the workings of a dowel.

ii. Second Portion

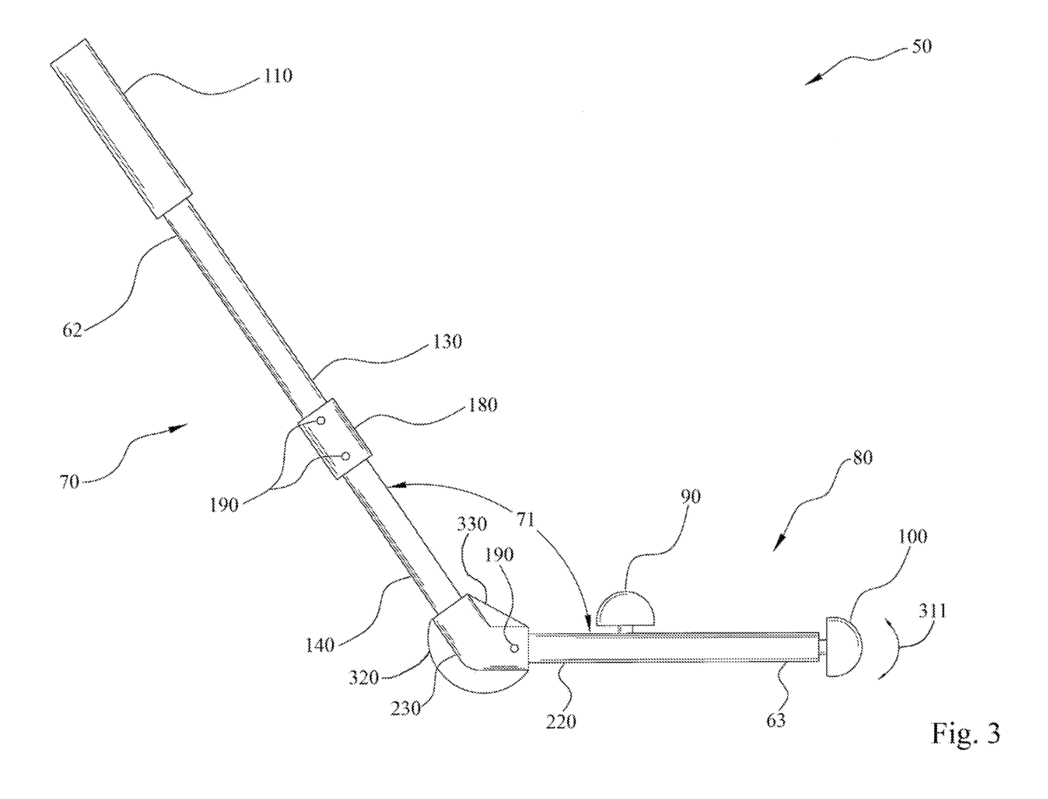

The second portion 80 extends from the first portion 70, wherein an obtuse angle 71 is defined between the first portion 70 and the second portion 80, see FIGS. 3 and 10, wherein the obtuse angle 71 is preferably about 140 degrees. The second portion 80 and the first portion 70 may be comprised of an integrally formed structure as illustrated in FIGS. 9 and 10 or may be comprised of a plurality of sections 130, 140, 220 removably connected together as illustrated in FIGS. 1 through 3. In the preferred embodiment, the second portion 80 is substantially shorter in length than the first portion 70. When comprised of the removable sections 130, 140, 220, an angled coupler 230 is preferably utilized between the second section 140 and the third section 220 to connect the first portion 70 to the second portion 80.

The second portion 80 includes a plurality of second connecting portions 240 spaced along a longitudinal axis of the second portion 80 as illustrated in FIGS. 1 and 2. The second connecting portions 240 are also directed towards the area formed between the first portion 70 and the second portion 80 and the side of the elongated support 60 that is positioned adjacent the user 350 while in use (similar to the first connecting portions 150).

The second connecting portions 240 are also preferably perpendicular to the longitudinal axis of the second portion 80. The second connecting portions 240 may extend from the second portion 80 or may extend within the second portion 80 as in an opening configuration. When the second connecting portion 240 is configured as an opening, it is appreciated that the opening 240 may extend partially or completely through the second portion 80 as illustrated in FIGS. 7 and 8. The second portion 80 includes the plurality of second connecting portions 240 to allow the user 350 to adjust the positioning of the inner massaging device 90 at various longitudinal positions upon the second portion 80 or to connect a plurality of inner massaging devices 90 to the second portion 80.

The second connecting portions 240 may also be threadably formed as illustrated in FIG. 7. The second connecting portions 240 may also include a second recessed portion to receive the head of a bolt (i.e. attachment member 160) as illustrated in FIG. 8. The head of the attachment member 160 thus remains flush with the outside of the elongated support 60 to prevent the head from engaging the user 350 when utilizing the present invention. The second portion 80 may be comprised of a third section 220 as illustrated in FIGS. 1 through 6. The third section 220 is removably connected to the second section 140 via extending within opposing ends of a second channel 250 of the angled coupler 230. The angled coupler 230 may be comprised of various configurations all which efficiently connect the third section 220 to the second section 140. It is appreciated that the third section 220 and the second section 140 may be secured to the angled coupler 230 via various methods, such as but not limited to fasteners 190 extending through attachment openings 200, 210 as illustrated in FIG. 2 and similar to the workings of a dowel. Adjoining ends of the second section 140 and the third section 220 may also be directly attached in various other manners, such as through the use of brackets extending along the outer sides of the second section 140 and the third section 220.

The second portion 80 also preferably includes an outer connecting portion 260 to receive or connect to an outer massaging device 100 as illustrated in FIGS. 1 through 11. The outer connecting portion 260 may be comprised of various configurations (e.g. opening, etc.) all which allow the outer massaging device 100 to connect to the outer connecting portion 260 of the second portion 80. The outer connecting portion 260 is also preferably positioned at an outer end 63 of the second portion 80, wherein the outer connecting portion 260 is substantially parallel and concentric with the longitudinal axis of the second portion 80.

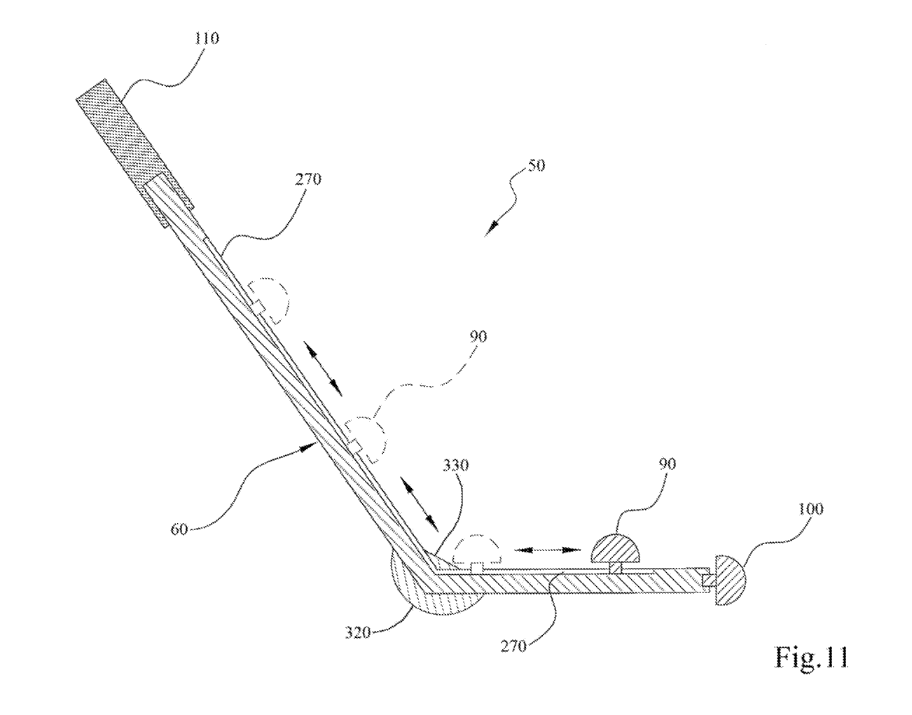

It is also appreciated that in place of the plurality of first connecting portions 150 and second connecting portions 240, an elongated slot 270 may extend within the elongated support 60 along a longitudinal axis and inner side of the elongated support 60 as illustrated in FIGS. 9 and 11. The slot 270 allows the inner massaging device(s) 90 to be positioned at various positions along the longitudinal axis of the elongated support 60 as illustrated in FIG. 11. It is also appreciated that the elongated support 60 may include a retaining means adjacent the slot 270 to allow the inner massaging device 90 to be removably secured at the desired position within the slot 270 with respect to the longitudinal axis of the elongated support 60.

### C. Massage Devices

The present invention preferably includes a plurality of massaging devices 90, 100 extending from the elongated support 60 as illustrated in FIGS. 1 through 6, noting that massaging devices 90, 100 may have positional orientations other than those shown. In the preferred embodiment, the massaging devices 90, 100 are comprised of a ball shaped configuration; however it is appreciated that the massaging devices 90, 100 may be comprised of various configurations all which provide a soothing or effective massage upon the user 350. The massaging devices 90, 100 may be comprised of various materials all which provide for a smooth and effective massaging surface, such as but not limited to metal.

The present invention preferably includes at least one inner massaging device 90 and at least one outer massaging device 100 as illustrated in FIGS. 1 through 6. The inner massaging device(s) 90 is positioned perpendicular to the longitudinal axis of the elongated support 60 and the outer massaging device 100 is positioned substantially parallel and concentric to the elongated support 60. The inner massaging device(s) 90 includes a first attachment portion 280 to connect the inner massaging device 90 to the elongated support 60. The first attachment portion 280 may extend from the inner massaging device 90 as illustrated in FIGS. 2, 6, 7, and 11, or may extend within the inner massaging device 90 as illustrated in FIG. 8.

The first attachment portion 280 may also be threadably formed so as to receive an attachment member 160 as illustrated in FIG. 8 or threadably attach to the elongated support 60 as illustrated in FIG. 7. It is appreciated that the various connecting manners described to attach the inner massaging device 90 to the elongated support 60 may be interchanged or combined to connect the inner massaging device 90 to the elongated support 60 in various manners. It is also appreciated that the inner massaging device 90 may be secured to the elongated support 60 in various manners other than those previously described.

The first massaging portion 290 of the inner massaging device 90 is preferably comprised of a dome or semi-circular shaped configuration as illustrated in FIGS. 1 through 11. The first massaging portion 290 is also preferably comprised of a smooth configuration. The outer massaging device 100 may be connected to the outer connecting portion 260 in various manners similar to or different than the inner massaging device 90. The outer massaging device 100 is also preferably able to swivel or pivot about the outer end 63 of the elongated support 60 as illustrated in FIG. 3. The outer massaging device 100 includes a second attachment portion 300 to connect the outer massaging device 100 to the elongated support 60 in a swiveling or pivotal manner, wherein the outer massaging device 100 may swivel or lock in various positions about the elongated support 60. It is also appreciated that the outer massaging device 100 may be fixedly attached to the elongated support 60.

The second massaging portion 310 of the outer massaging device 100 is preferably comprised of a dome or semi-circular shaped configuration as illustrated in FIGS. 1 through 11. The second massaging portion 310 is also preferably comprised of a smooth configuration.

The personal massaging system 50 includes an elongated support 60 including a first linear portion 70 with a longer moment arm 380 and a second linear portion 80 with a shorter moment arm 390, wherein the first linear portion 70 extends from the second linear portion 80. Further, in the personal massaging system 50 the first linear portion 70 is positioned at an obtuse angle 71 in relation to the second linear portion 80, wherein preferably the obtuse angle 71 is about one-hundred forty degrees, although the obtuse angle 71 could range from about one-hundred degrees to one-hundred and seventy degrees for the personal massaging system 50 to function in using the fulcrum pivot point at the arcuate extension 320. Also included in the personal massaging system 50 is the arcuate extension 320 that is disposed where the first linear portion 70 extends from the second linear portion 80. Further included in the personal massaging system 50 is the one massaging device 90, 100, wherein at least one massaging device 90, 100, extends from the elongated support 60. Wherein operationally the arcuate extension 320 provides a fixed fulcrum pivot upon a surface 340 facilitating an increased force 341 at the second linear portion 80 from a lower selected force 342 at the first linear portion 70 effectuated by the user 350, as best shown in use FIGS. 12 through 16.

Optionally, the personal massaging system 50 can further comprise a reinforcing rib 330 disposed opposite of the arcuate extension 320, wherein operationally the reinforcing rib 330 distributes loading from a moment 400 between the first linear portion 70 and the second linear portion 80 from the fixed fulcrum pivot at the arcuate extension 320, as best shown in FIGS. 1 and 10. Also in the personal massaging system 50 at least one massaging device 90, 100 can be swivally connected 311 to the elongated support, as shown in FIGS. 3 and 10. Alternatively, on the personal massaging system 50 at least one massaging device 90, 100 is adjustable along a longitudinal axis of the elongated support 60, as best shown in FIGS. 1, 2, and 11.

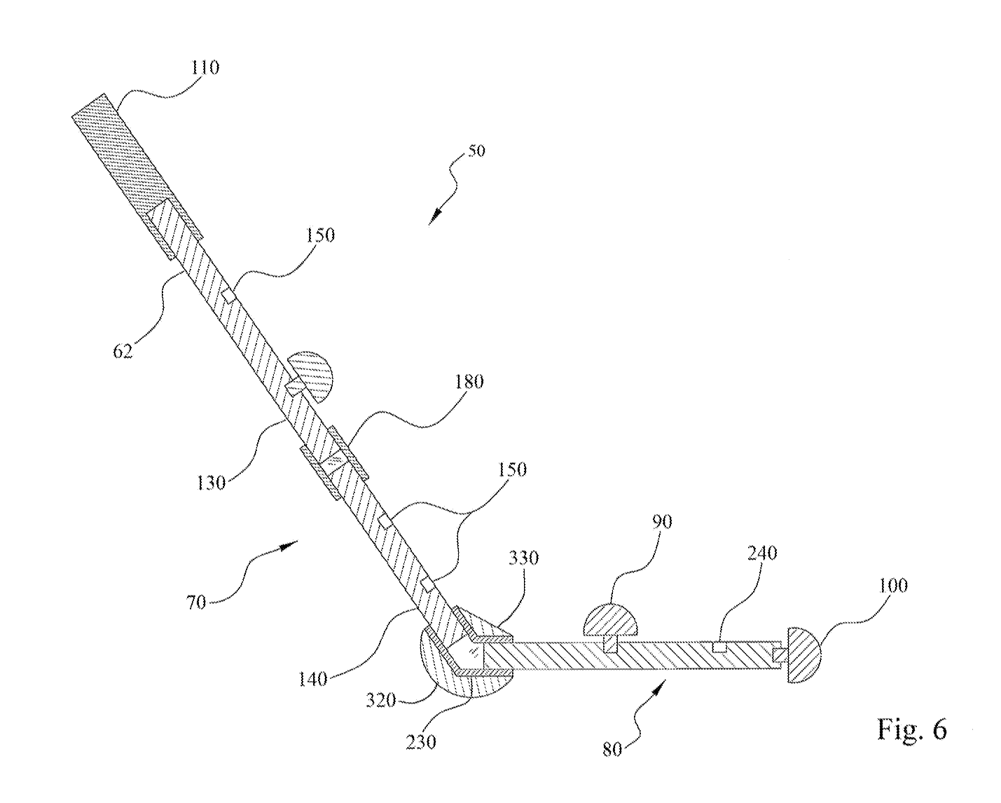

Also, optionally the personal massaging system 50 at least one massaging device 90, 100, includes an outer massaging device 100 and at least one inner massaging device 90. Wherein the outer massaging device 100 is substantially concentric with a first longitudinal axis of the elongated support 60 and the inner massaging device 90 is substantially perpendicular to the elongated support, as best shown in FIGS. 6, 7, 8, and 11. In addition, the elongated support 60 could include at least one elongated slot 270, wherein at least one massaging device 90, 100 slidably adjusts within the at least one elongated slot 270, as best shown in FIGS. 9 and 11. Further, the elongated slot 270 is parallel with a longitudinal axis of the elongated support 60.

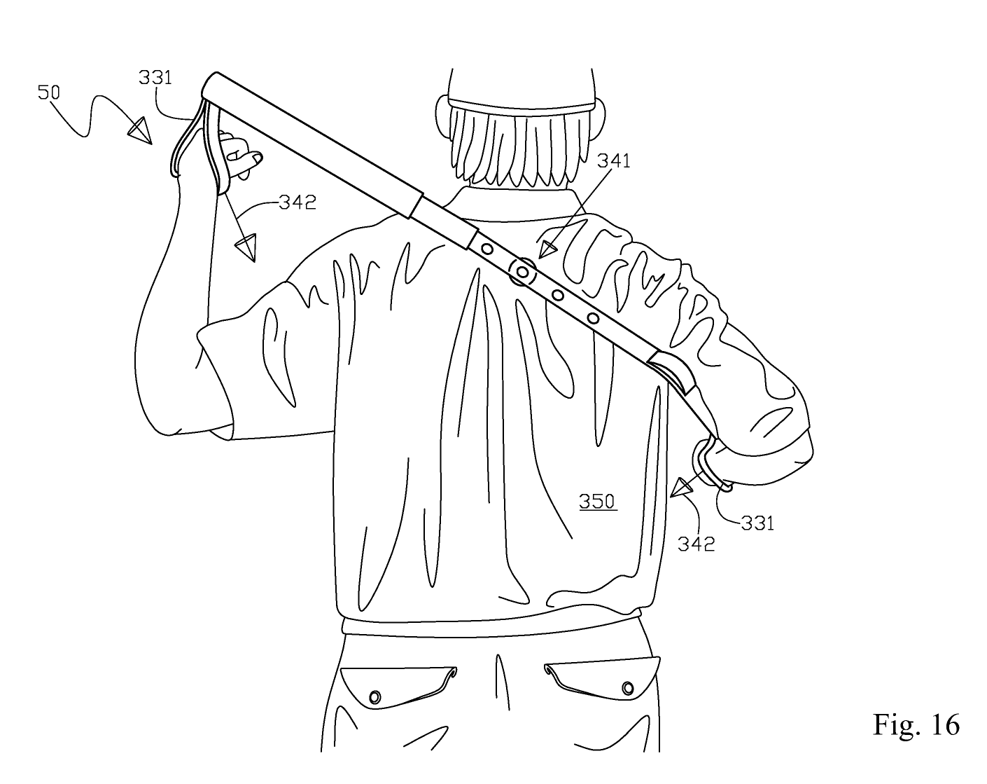

Also, the personal massaging system 50 can include a handle 110 extending from the first linear portion 70, as best shown in FIGS. 1-3 and 9-11. Further, the elongated support 60 is comprised of a rigid structure. Optionally, on the personal massaging system 50 can further comprising a pair of straps 331, one each disposed on the first linear portion 70 and the second linear portion 80, wherein operationally the pair of straps 331 facilitate a user 350 applying a force 342 at each strap 331 to create a force 341 at the massaging device 90, 100, as best show in FIG. 16.

### Method of Use

### D. Operation of Preferred Embodiment

In use, the present invention is first assembled (if not already done so). The inner massaging device(s) 90 is also adjusted to a desired position along the longitudinal axis of the elongated support 60. The user 350 now preferably grasps the handle 110 and positions the massaging device 90, 100 upon or between a desired muscle and subsequently applies pressure. It is appreciated that a piece of clothing or cloth may be positioned between the massaging device 90, 100 and the skin of the user 350 to allow the massaging device 90, 100 to glide more easily along the user 350.

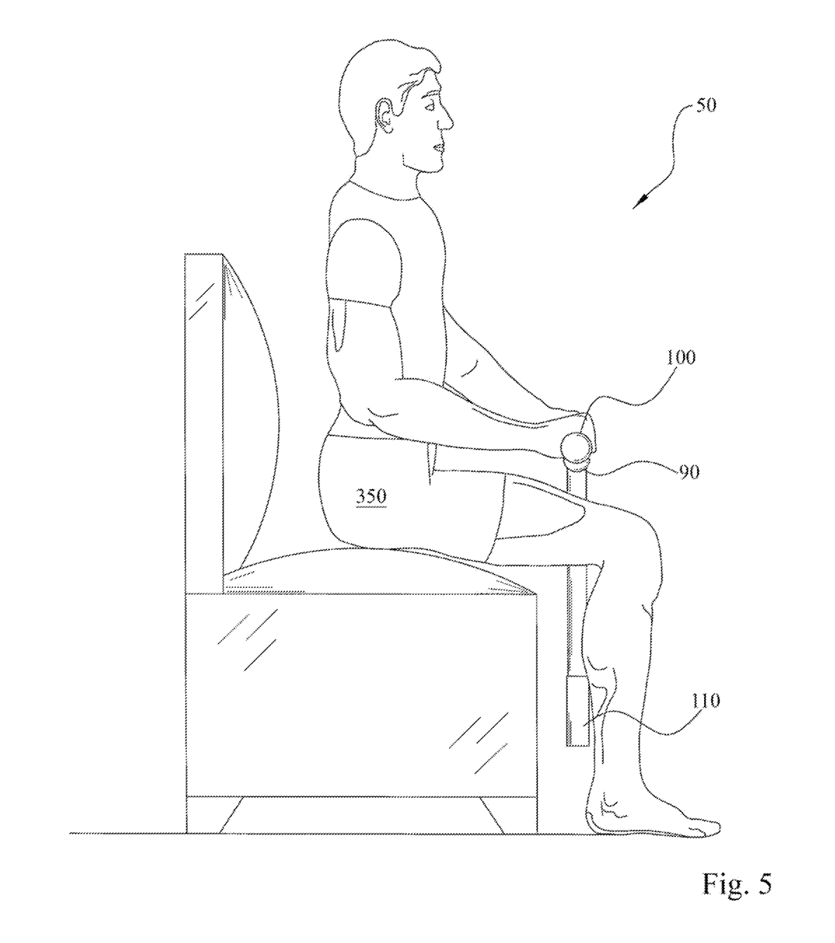

The elongated support 60 is now maneuvered so as to massage the desired muscle with the massaging device 90, 100. It is appreciated that various massaging techniques may be utilized (e.g. shiatsu, etc.). It is appreciated that the present invention may be utilized for hard-to-reach areas (e.g. back, etc.) of the user 350 as illustrated in FIGS. 4 and 12 through 16, or easy-to-reach areas (e.g. legs, etc.) of the user 350 as illustrated in FIG. 5.

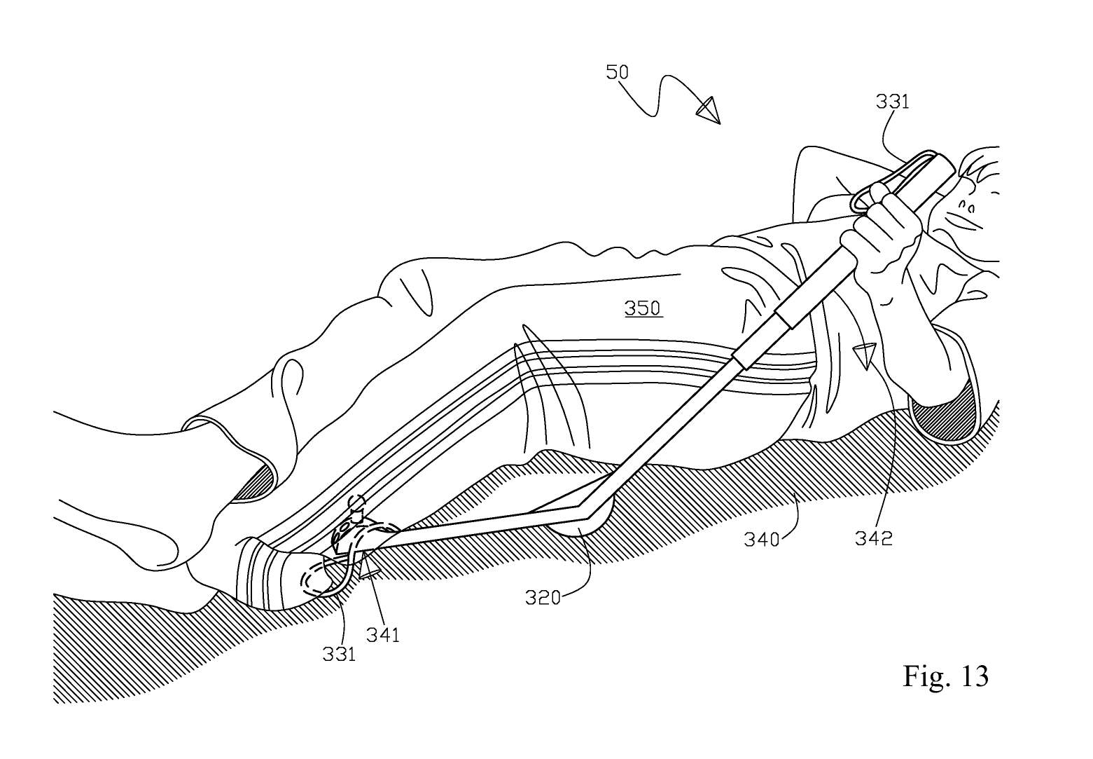

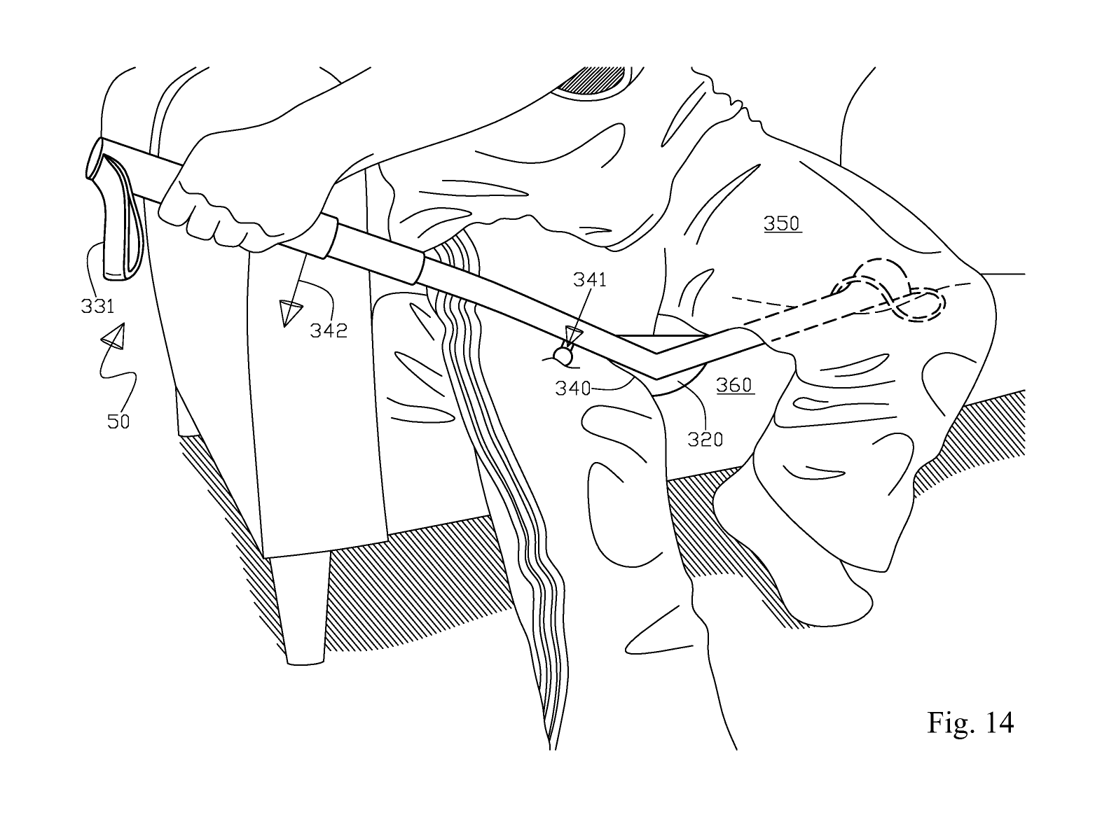

Looking at particular to FIG. 12 shown is a perspective view of the personal massaging system 50 in use utilizing the arcuate extension 320 as a fulcrum pivot point on the surface 340 on a floor to gain leverage for the force 341 to be applied at the first massage portion 290 via the handle 110 from the user 350 applying force 342. Next, FIG. 13 shows a perspective view of the personal massaging system 50 in use utilizing the arcuate extension 320 again as a fulcrum pivot point on the surface 340 on a floor to gain leverage for the force 341 to be applied at the first massage portion 290 via the handle 110 from the user 350 applying force 342 in a more remote location. Continuing, FIG. 14 shows a perspective view of the personal massaging system 50 in use utilizing the arcuate extension 320 as a fulcrum pivot point and the massage device 90 as against the user's 350 leg with the second portion 80 trapped between the user's 350 other leg and the couch seat 360 with the user 350 pushing 342 down on the handle 110 creating an end pivot at the second portion opposite 80 of the handle 110 while adding force 341 to the massaging device 90.

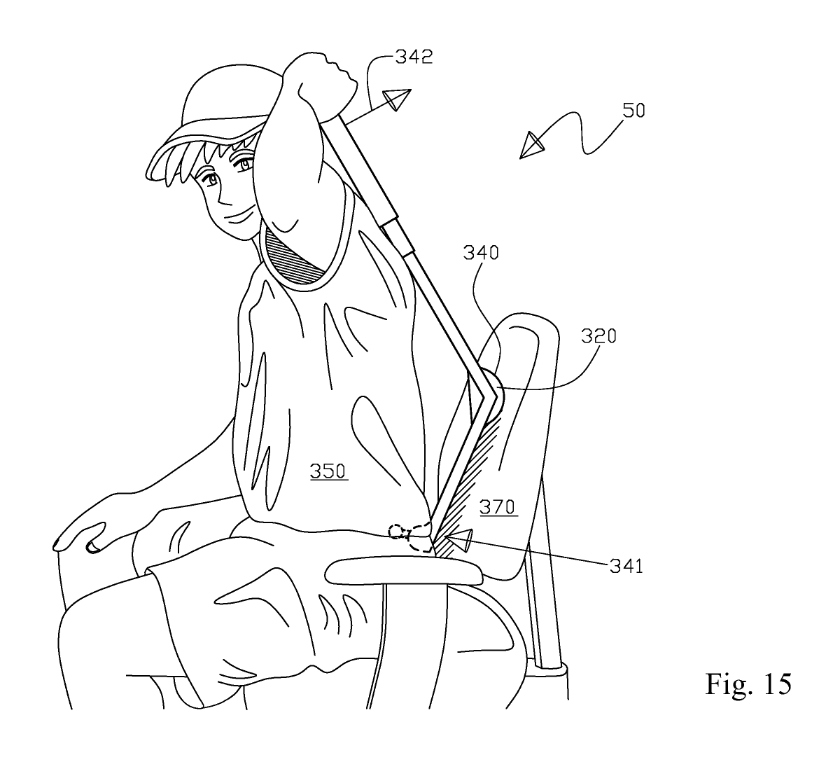

Further, FIG. 15 shows a perspective view of the personal massaging system 50 in use utilizing the arcuate extension 320 again as a fulcrum pivot point on the surface 340 on a chair back 370 to gain leverage for the force 341 to be applied at the first massage portion 90 or 100 via the handle 110 from the user 350 applying force 342 in a more remote location on the user's 350 back. Continuing, FIG. 16 shows a perspective view of the personal massaging system 50 in use utilizing the retention straps 331 disposed at the handle 110 and the opposing second portion 80 allowing the user 350 to apply force 342 at the retention straps 331 to effectuate massage force 341 at selected locations on the user's 350 back from the massaging device 90, 100, 290, or 310.

What has been described and illustrated herein is a preferred embodiment of the invention along with some of its variations. The terms, descriptions and figures used herein are set forth by way of illustration only and are not meant as limitations. Those skilled in the art will recognize that many variations are possible within the spirit and scope of the invention, which is intended to be defined by the following claims (and their equivalents) in which all terms are meant in their broadest reasonable sense unless otherwise indicated. Any headings utilized within the description are for convenience only and have no legal or limiting effect.

### CONCLUSION

Accordingly, the present invention of a personal massaging system 50 has been described with some degree of particularity directed to the embodiment(s) of the present invention. It should be appreciated, though; that the present invention is defined by the following claims construed in light of the prior art so modifications or changes may be made to the exemplary embodiment(s) of the present invention without departing from the inventive concepts contained therein.

1. A personal massaging system, comprising:
(a) an elongated support including a first linear portion with a longer moment arm and a second linear portion with a shorter moment arm, wherein said first linear portion extends from said second linear portion; wherein said first linear portion is positioned at an obtuse angle in relation to said second linear portion;
(b) an arcuate extension disposed where said first linear portion extends from said second linear portion; and
(b) at least one massaging device, wherein said at least one massaging device extends from said elongated support, wherein operationally said arcuate extension provides a fixed fulcrum pivot upon a surface facilitating an increased force at said second linear portion from a lower selected force at said first linear portion.

2. A personal massaging system according to claim 1, wherein said obtuse angle is about one-hundred forty (140) degrees.

3. A personal massaging system according to claim 1, further comprising a reinforcing rib disposed opposite of said arcuate extension where said first linear portion extends from said second linear portion. wherein operationally said reinforcing rib distributes loading from a moment between said first linear portion and said second linear portion from said fixed fulcrum pivot.

4. A personal massaging system according to claim 3, wherein said at least one massaging device is swivally connected to said elongated support.

5. A personal massaging system according to claim 3, wherein said at least one massaging device is adjustable along a longitudinal axis of said elongated support.

6. A personal massaging system according to claim 3, wherein said at least one massaging device includes an outer massaging device and at least one inner massaging device.

7. A personal massaging system according to claim 6, wherein said outer massaging device is substantially concentric with a first longitudinal axis of said elongated support and wherein said at least one inner massaging device is substantially perpendicular to said elongated support.

8. A personal massaging system according to claim 3, wherein said elongated support includes at least one elongated slot, wherein said at least one massaging device slidably adjusts within said at least one elongated slot.

9. A personal massaging system according to claim 8, wherein said at least one elongated slot is parallel with a longitudinal axis of said elongated support.

10. A personal massaging system according to claim 1, including a handle extending from said first linear portion.

11. A personal massaging system according to claim 1, wherein said elongated support is comprised of a rigid structure.

12. A personal massaging system according to claim 1 further comprising a pair of straps, one each disposed on said first linear portion and said second linear portion, wherein operationally said pair of straps facilitate a user applying a force at each strap to create a force at said massaging device.

13. A personal massaging system, comprising:
(a) an elongated support including a first linear portion with a longer moment arm and a second linear portion with a shorter moment arm, wherein said first linear portion extends from said second linear portion; wherein said first linear portion is positioned at an obtuse angle in relation to said second linear portion;
(b) an arcuate extension disposed where said first linear portion extends from said second linear portion;
(c) a reinforcing rib disposed opposite of said arcuate extension where said first linear portion extends from said second linear portion; and
(d) at least one massaging device, wherein said at least one massaging device extends from said elongated support, wherein operationally said arcuate extension provides a fixed fulcrum pivot upon a surface facilitating an increased force at said second linear portion from a lower selected force at said first linear portion, wherein operationally said reinforcing rib distributes loading from a moment between said first linear portion and said second linear portion from said fixed fulcrum pivot.

14. A personal massaging system according to claim 13, wherein said at least one massaging device is swivally connected to said elongated support.

15. A personal massaging system according to claim 13, wherein said at least one massaging device is adjustable along a longitudinal axis of said elongated support.

16. A personal massaging system according to claim 13, wherein said at least one massaging device includes an outer massaging device and at least one inner massaging device.

17. A personal massaging system according to claim 16, wherein said outer massaging device is substantially concentric with a first longitudinal axis of said elongated support and wherein said at least one inner massaging device is substantially perpendicular to said elongated support.

18. A personal massaging system according to claim 13, wherein said elongated support includes at least one elongated slot, wherein said at least one massaging device slidably adjusts within said at least one elongated slot.

19. A personal massaging system according to claim 18, wherein said at least one elongated slot is parallel with a longitudinal axis of said elongated support.

20. A personal massaging system according to claim 13 further comprising a pair of straps, one each disposed on said first linear portion and said second linear portion, wherein operationally said pair of straps facilitate a user applying a force at each strap to create a force at said massaging device.
